(19) United States
(12) Patent Application Publication
(10) Pub. No.: US 2006/0191273 A1
(43) Pub. Date: Aug. 31, 2006

(54) Thermostat having preset time setting

(76) Inventors: Carl J. Mueller, St. Louis, MO (US); Bartholomew L. Toth, St. Louis, MO (US); John M. Sartain, St. Louis, MO (US); Esan A. Alhilo, St. Louis, MO (US)

Correspondence Address: HARNESS, DICKEY, & PIERCE, P.L.C, 7700 BONHOMME, STE 400, ST. LOUIS, MO, 63105, US

(21) Appl. No.: 11/068,060

(22) Filed: Feb. 28, 2005

(51) Int. Cl. B64D 13/00; F25D 17/04

(52) U.S. Cl. 62/186; 236/91 D

(57) ABSTRACT

A digital thermostat having a plurality of user input buttons, a display, a battery, a real time clock, a memory and a processor that is capable of receiving initial time and date information and storing the information in memory. The initial time and date information is then provided to the real time clock for maintaining the current time in the thermostat. The user is prompted by the program to select and enter a time zone setting, after which the current date and local time is automatically set and shown on the thermostat display.

### FIELD OF THE INVENTION

The present invention is generally related to programmable thermostats, and more particularly to a programmable thermostat with a preset time clock feature.

### BACKGROUND OF THE INVENTION

Numerous programmable thermostats exist that provide for entry of time and date information by the user of the thermostat. Such thermostats typically require the user to complete a complex series of steps to enter time and date information before the user can program the thermostat. Due to the complexity of inputting information to the thermostat, many users do not set the time or utilize the programming features that could reduce their energy costs. One approach to this problem is to enable the thermostat to receive a time information signal broadcast at 60 kHz by station WWVB for setting the current time. However, buildings and walls surrounding the thermostat often interfere with the reception of this signal. Such a thermostat may not receive the WWVB signal until 3 AM when the broadcast signal strength is increased for a brief time. Thus, the thermostat may still require the user to perform the undesirable step of entering the time setting in order to program the thermostat after installation.

### SUMMARY OF THE INVENTION

There are provided, in accordance with one aspect of the invention, various embodiments of a digital programmable thermostat that comprise preset information that eliminates the need for the user to enter the time and date information. In one embodiment of a thermostat in accordance with the present invention, the thermostat comprises a battery for powering the thermostat, a connection means for receiving an input signal of time and date data from a device external to the thermostat, a memory for storing the time and date information, a real time clock for subsequently maintaining the current time setting after initial input of the time and date information, and a display means for displaying time and temperature information. The thermostat further comprises a processor for controlling the thermostat, where upon activation of the thermostat by the user, the processor prompts the user to select a time zone. After selection of a time zone, the processor responsively provides the display means with the local time setting for display. The current time and date information are input to the connection means of the thermostat at the time of production.

In some embodiments, the thermostat further comprises a switch means for switching the processor to a low power usage mode for disabling all thermostat operation with the exception of the real time clock function, and also a restoration means for restoring the processor to a normal power usage mode and initiating thermostat operation. Once the time is entered into memory, the processor is switched to a low power usage mode that restricts thermostat operation to that of maintaining the real time clock. At the time of installation, the user or installer can use the restoration means to restore the processor to normal power usage mode. In one embodiment, the restoration means comprises at least one user input means that may be depressed for a predetermined minimum time period to restore the processor to normal power usage mode. A program in the processor then prompts the user to select and enter a time zone, after which the thermostat adjusts the time setting and shows the day and local time on the thermostat display.

In another aspect of the present invention, some embodiments of a thermostat comprise a processor having an input port pin for connecting to an external device to receive initial time and date information at the time of production of the thermostat, a memory means for storing the initial time and date setting received by the processor, a real time clock that is set to the initial time and date setting and subsequently maintains the actual time, a switch means for switching the processor to a low power usage mode that disables all thermostat operation with the exception of the real time clock function, and a restoration means for restoring the processor to normal operation, in which the processor prompts the user to select a time zone. The thermostat is capable of being set with current time data and switched to a low power mode, to provide a thermostat with a preset time and date feature while prolonging the life of the thermostat battery.

### BRIEF DESCRIPTION OF THE DRAWINGS

FIG. 1 is a front view of one embodiment of a thermostat having user inputs and a display for showing a preset time in accordance with the principles of the present invention; and

FIG. 2 is a schematic of one embodiment of a thermostat comprising a user input means in accordance with the principles of the present invention.

### DETAILED DESCRIPTION OF THE INVENTION

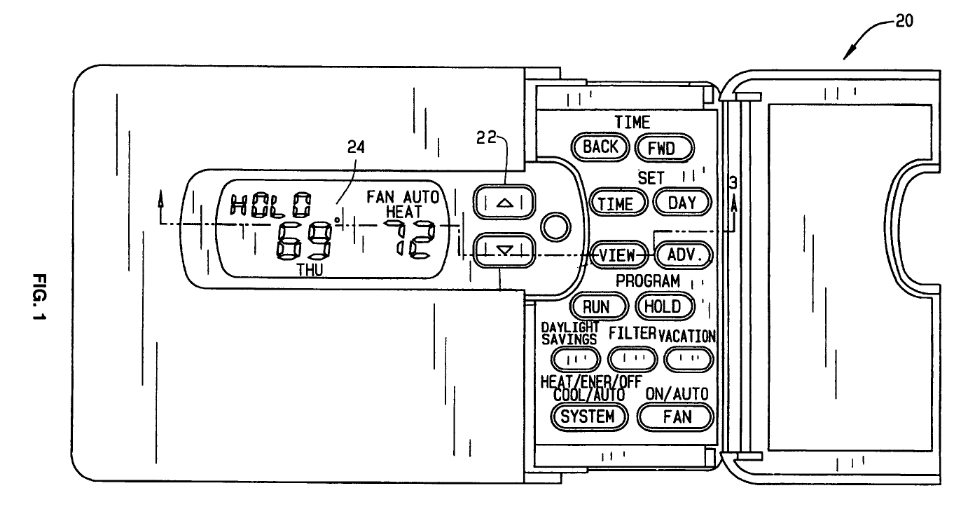

One embodiment of a thermostat incorporating the preset time feature according to the principles of the present invention is generally shown at 20 in FIG. 1. The thermostat 20 comprises a display means 24, and at least one input means 22 on the thermostat 20, for enabling the user to enter the thermostat into a normal operating mode, as will be described in further detail in the various embodiments below.

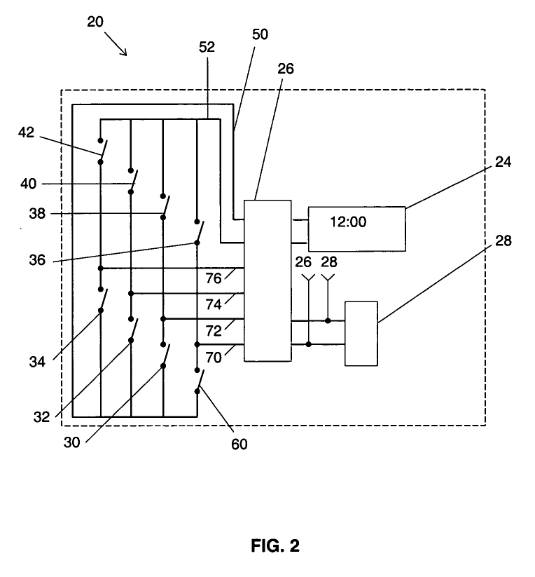

Referring to FIG. 2, one embodiment of a thermostat 20 comprises a microprocessor 26, user-input means 30-42, an LCD display 24 and a real time clock (not shown) for maintaining time and date information. As shown in FIG. 1, the thermostat 20 further comprises data input connection means 46 and 48 for receiving input of initial time and date information to the thermostat. In this embodiment, the input connection means 46 and 48 are connected to data input ports of a microprocessor 26. At the time of production of the thermostat 20, the connections 46 and 48 are connected to production devices or test equipment external to the thermostat 20, for the purpose of testing the thermostat's operation. Upon completion of testing, the external device communicates a signal comprising the current time and date information through the input connections 46 and 48 to the data input pins of the microprocessor 26. The microprocessor 26 then communicates the time and date information to a non-volatile EEPROM memory 28 for storing the information. In some embodiments of the present invention, the EEPROM memory 28 is a memory chip external to the microprocessor 26, but other embodiments may alternately incorporate the EEPROM memory into the microprocessor 26. A real time clock is then updated by the microprocessor 26 with the initial time and date information to establish a preset time. The real time clock is preferably a 32 Khz crystal, part number DT-38 manufactured by Daiwa, but could also be an oscillator or other component suitable for keeping time. From the moment time and date information is provided to the real time clock, the real time clock subsequently maintains current time until the thermostat is activated by a user.

The thermostat 20 further comprises a series of switches in connection with the microprocessor 26. The microprocessor is capable of sending at least two pulse signals to the series of switches, to enable multiplexing of inputs to the microprocessor 26. For example, the user can enter a Temperature Down Adjustment or Temperature Up Adjustment input to the microprocessor 26 by pressing a button for closing a switch 30 or 32 respectively. The user can enter the thermostat into Hold Temperature mode by pressing a button that closes switch 34. The input for Viewing Program settings of the thermostat 20 is accomplished by pressing a button for closing switch 36. The input to Run the program of the thermostat is accomplished by pressing a button for closing switch 38. The user can also change the preset time setting by pressing a button for closing switch 40 to enter the Time Set mode. The switches 30, 32, 34, 36, 38, 40 and 42 allow the user to provide various input entries to the thermostat, which are input to the microprocessor 26 via input pins 70, 72, 74 and 76. Specifically, when the microprocessor 26 sends a first pulse signal at 50 to a switch 32 that has been closed by the user, the microprocessor 26 receives the first pulse signal input at pin 72 to indicate the user has entered a Temperature Up adjustment input. Similarly, when the microprocessor 26 sends a second pulse at 52 to a switch 34 that has been closed by the user, the microprocessor 26 receives the second pulse signal input at pin 74 to indicate the user has entered the thermostat into Hold Temperature mode. One example of such an embodiment of a thermostat is a 1F95-479 thermostat manufactured by White-Rodgers, a Division of Emerson Electric.

In one embodiment, the thermostat 20 comprises an internal switch 60 within the series of switches connected to the microprocessor 26. The internal switch 60 is not readily accessible to the user of the thermostat, and is switched at the time of production to signal the microprocessor 26 to enter into a low power usage mode. Once the initial time information has been entered at the time of production, the switch 60 is momentarily closed to provide a first pulse signal 50 to input 70 of the microprocessor. The microprocessor 26 responds to this particular input by initiating shut down of the thermostat's LCD display, program, and other functions other than the real time clock function. In this low power usage mode, the microprocessor 26 consumes approximately of six micro-amps from the thermostat battery (not shown). The low current draw helps prolong the life of the battery until the thermostat is received by the consumer or user.

Once the thermostat 20 has been received by the installer, ultimate consumer, or user, the microprocessor 26 can be restored to normal power usage mode by pressing any thermostat button for more than a minimum predetermined time period. In one embodiment of the present invention, the minimum predetermined time period is preferably 3 seconds, but may alternatively be any time period suitable for the application. Pressing any button will provide an input signal to any of the inputs 70, 72, 74 or 76 of the microprocessor 26, which responsively restores normal power usage mode for the microprocessor 26. This action by the user for restoring normal power to the microprocessor 26 activates the thermostat 20, to allow the microprocessor to initiate a program within the microprocessor. The program within the microprocessor 26 defaults to a Time Zone Entry prompt. Specifically, the program initiates the display of the default Eastern Time Zone setting on the thermostat's LCD, and prompts the user to select the desired Time Zone setting using the Temperature Adjustment buttons. The user is then prompted to enter the selected time zone setting by pressing the Run Program button of the thermostat 20. Upon entry of the local time zone setting, the microprocessor 26 responsively updates the real time clock setting to reflect the local time setting corresponding to the entered time zone setting. The program then initiates the display of the current day and local time on the thermostat's LCD display. Upon establishing the time setting for the thermostat, a program of the microprocessor controls the normal operation of the thermostat 20. This program is also configured to automatically adjust the time setting to allow for daylight savings time. Because such software programs for controlling a thermostat's normal operation and temperature settings are prevalently used and well known in the art, the software program will not be described in detail.

It should be noted that the selection and entry of the time zone setting may alternatively be performed using any other combination of user input buttons on the thermostat 20. Likewise, the means of restoring the thermostat to normal power usage mode may also be accomplished using a specific button or combination of buttons simultaneously pressed by the user of the thermostat. The thermostat 20 may also be configured to display the date and local time zone information on the LCD display, in addition to the day and local time.

Additional design considerations, readily apparent to one of ordinary skill in the art, such as the modification of the thermostat to provide date information on the LCD display may also improve the user's ability to program the thermostat. It should be apparent to those skilled in the art that various modifications such as the above may be made without departing from the spirit and scope of the invention. More particularly, the apparatus may be adapted to any digital thermostat independent of programming capability. Accordingly, it is not intended that the invention be limited by the particular form illustrated and described above, but by the appended claims.

What is claimed is:

1. A digital thermostat having a user input means for raising or lowering the temperature setting, the thermostat comprising:
a battery for powering the thermostat;
a processor having an input port pin for connecting to an external device to receive initial time and date information at the time of production of the thermostat;
a memory means for storing the initial time and date setting received by the processor;
a real time clock that is set to the initial time and date setting and subsequently maintains the actual time;
a switch means for switching the processor to a low power usage mode that disables all thermostat operation with the exception of the real time clock function; and
a restoration means for restoring the processor to normal operation, in which the processor prompts the user to select a time zone from a set of time zone settings; and
a display means for displaying the local time information.

2. The digital thermostat of claim 1, wherein the switch means comprises a momentary switch located on the inside of the thermostat.

3. The digital thermostat of claim 2, wherein the restoration means comprises at least one user input button on the thermostat that is pressed for a minimum predetermined time period.

4. The digital thermostat of claim 3, wherein the processor comprises a software program that prompts the thermostat user to select a time zone from a set of time zone settings upon restoration of the normal operation of the processor.

5. The digital thermostat of claim 4, wherein the time zone setting is selected from the group consisting of pacific standard time, mountain standard time, central standard time, eastern standard time.

6. The digital thermostat of claim 4, wherein the thermostat begins operating at a default temperature setting upon entry of the time zone setting by the user.

7. The digital thermostat of claim 4, where upon entry of the time zone setting, the display means displays the real time clock setting offset by an amount corresponding to the selected local time zone.

8. A thermostat for controlling a climate control system, the thermostat comprising:
a battery for powering the thermostat;
a connection means for receiving an input signal of time and date data from a device external to the thermostat;
a memory for storing the time and date information;
a real time clock for subsequently maintaining the current time setting after initial input of the time and date information; and
a display means for displaying time and temperature information, and
a processor for controlling the thermostat, where upon activation of the thermostat, the processor prompts the user to select a time zone and responsively provides the display means with the day and local time setting for display.

9. The thermostat of claim 8, wherein the initial time and date information is supplied to the data input means at the time of production of the thermostat.

10. The thermostat of claim 9, wherein the processor is switched into a low power usage mode at the time the initial time and date information is input to the thermostat.

11. The thermostat of claim 10, wherein the processor is restored to a normal power usage mode when the user presses at least one input button of the thermostat for a minimum predetermined time period.

12. The thermostat of claim 11, wherein the program initiates the control of the thermostat system upon entry of a time zone setting by the user.

13. The thermostat of claim 12, wherein the program will not enable operation of the thermostat until the user has selected and entered a time zone setting.

14. An improved programmable digital thermostat comprising:
a battery for powering the thermostat;
a processor having an input port pin for receiving an initial current time and date setting from an external device;
a memory means for storing the initial time and date setting received by the processor;
a real time clock that is set to the initial time and date setting and subsequently maintains the actual time;
a switch means for switching the processor to a low power usage mode that disables all thermostat operation with the exception of the real time clock function;
a restoration means for restoring the processor to a normal power usage mode and initiates a software program that prompts the user to select a time zone from a set of time zone settings; and
a display means for displaying time and temperature information.

15. The improved programmable digital thermostat of claim 14, wherein the initial current time and date setting is input to the processor at the time of production of the thermostat.

16. The improved programmable digital thermostat of claim 15, wherein the restoration means comprises at least one of the user input buttons on the thermostat that is depressed for a minimum predetermined time period.

17. The improved programmable digital thermostat of claim 16, wherein the processor comprises a software program that prompts the thermostat user to select a time zone from a set of time zone settings upon restoration of the processor to normal power usage mode.

18. The improved programmable digital thermostat of claim 17, wherein the restoration means comprises at least two of the user input buttons on the thermostat that are simultaneously pressed for a minimum predetermined time period.

19. A method of controlling a thermostat having at least one user input button, a display, a data input connection; a memory, a battery, a real time clock and a processor that includes a program for controlling the operation of the thermostat, the method comprising the steps of:
inputting initial time and date information to the data input connection;
storing the initial time and date information in memory;
providing the initial time and date information to the real time clock for maintaining the current time setting;
switching the processor to a low power usage mode to conserve battery life.

20. The method of claim 19, further comprising the step of restoring the processor to normal power usage mode by pressing at least one user input button for a minimum predetermined time period.
